(19) United States
(12) Patent Application Publication
(10) Pub. No.: US 2025/0327929 A1
(43) Pub. Date: Oct. 23, 2025

(54) SENSOR APPARATUS

(71) Applicant: DENSO CORPORATION, Kariya-city (JP)

(72) Inventor: Kohei KUNO, Kariya-city (JP)

(21) Appl. No.: 19/182,130

(22) Filed: Apr. 17, 2025

(30) Foreign Application Priority Data
Apr. 19, 2024 (JP) 2024-068675

(51) Int. Cl. G01S 17/89; G01S 7/481; G01S 17/931; H04N 23/20; H04N 23/60

(52) U.S. Cl. CPC G01S 17/89; G01S 7/4813; G01S 17/931; H04N 23/20; H04N 23/60

(57) ABSTRACT

In a sensing apparatus, an electromagnetic wave generator is housed in a housing container. An electromagnetic wave transmission component is housed in the housing A sensing element is disposed further toward an inner side of the housing container. container than the electromagnetic wave transmission component. A control board is disposed further toward an inner side of the housing container than the electromagnetic wave transmission component. A housing is disposed between the electromagnetic wave transmission component and the sensing element and the control board, and configures a path guiding an electromagnetic wave transmitted through the electromagnetic wave transmission component to the sensing element. A fixing portion is configured as a separate member from the housing and fixes the electromagnetic wave transmission component to the housing. The electromagnetic wave generator generates heat during output of the electromagnetic wave and heat is transferred to the electromagnetic wave transmission component through the fixing portion.

### CROSS-REFERENCE TO RELATED APPLICATION

This application is based on and claims the benefit of priority from Japanese Patent Application No. 2024-068675, filed on Apr. 19, 2024, the description of which is incorporated herein by reference.

### BACKGROUND

The present disclosure relates to a sensor apparatus. The sensor apparatus is known that is suitable for application as a vehicle-mounted sensor such as a camera apparatus that is mounted in a vehicle.

### SUMMARY

An aspect of the present disclosure provides a sensing apparatus that includes a housing container, an electromagnetic wave generator, a sensing element, a control board, a housing, and a fixing portion. The electromagnetic wave generator is housed in the housing container. The electromagnetic wave transmission component is housed in the housing container. The sensing element is disposed further toward an inner side of the housing container than the electromagnetic wave transmission component is. The control board is disposed further toward an inner side of the housing container than the electromagnetic wave transmission component is. The housing is disposed between the electromagnetic wave transmission component and the sensing element and the control board, and configures a path guiding an electromagnetic wave transmitted through the electromagnetic wave transmission component to the sensing element. The fixing portion is configured as a separate member from the housing and fixes the electromagnetic wave transmission component to the housing. The electromagnetic wave generator generates heat during output of the electromagnetic wave and the heat is transferred to the electromagnetic wave transmission component through the fixing portion.

### BRIEF DESCRIPTION OF THE DRAWINGS

In the accompanying drawings:

FIG. 1 is a perspective view of a camera apparatus according to a first embodiment of the present disclosure;

FIG. 2 is a cross-sectional view of the camera apparatus shown in FIG. 1, taken along the line II-II in a Z-axis direction;

FIG. 3 is an exploded view of the camera apparatus shown in FIG. 1;

FIG. 4 is a partially enlarged view of an area R in FIG. 2;

FIG. 5 is a diagram illustrating a relationship between an optical axis of a lens barrel of the camera apparatus, an optical axis of an infrared irradiating unit, and an imaging range;

FIG. 6 is a diagram illustrating a vehicle in which a camera apparatus according to a second embodiment of the present disclosure is mounted;

FIG. 7 is a projection diagram of a side mirror showing a cross-section of the camera apparatus;

FIG. 8 is a partial projection diagram of a front fender, showing a cross-section of the camera apparatus;

FIG. 9 is a perspective view of a camera apparatus according to a third embodiment of the present disclosure;

FIG. 10 is a cross-sectional view of the camera apparatus shown in FIG. 9, taken on a YZ plane including an optical axis;

FIG. 11 is a cross-sectional view of the camera apparatus shown in FIG. 9, taken along the line XI-XI in the Z-axis direction;

FIG. 12 is an exploded view of the camera apparatus shown in FIG. 9;

FIG. 13 is a perspective view of a camera apparatus according to another embodiment;

FIG. 14 is a cross-sectional view of an example of a structure in which a gap is formed between a lens fixing portion and a lens barrel according to the other embodiment; and

FIG. 15 is a cross-sectional view of a camera apparatus according to another embodiment.

### DESCRIPTION OF THE EMBODIMENTS

In the past, JP 2014-035370 A has proposed a camera apparatus in which an infrared irradiation unit is disposed in a vicinity of a lens. The camera apparatus captures images of an object appearing in the lens by controlling an imaging unit configured by an imager or the like, and the near-infrared irradiation unit. In the camera apparatus, the infrared irradiation unit is controlled to enable imaging in a dark-field by infrared light being simultaneously irradiated during imaging by the imaging unit. The lens and the near-infrared irradiation unit are respectively attached to a lens attaching portion and a light attaching portion of a housing. When the infrared irradiation unit generates heat by irradiating infrared light, the heat is transferred to the lens, thereby removing lens fogging.

In recent years, there has been a demand for camera apparatuses to provide greater image clarity and greater dark-field visibility range, that is, to be capable of high-clarity sensing over a greater distance.

However, the camera apparatus in JP 2014-035370 A is structured such that the heat generated by the infrared irradiation unit is directly transferred to the housing from the infrared irradiating unit. In addition, the structure is such that the imager and an imager board on which the imager is mounted are disposed on a side opposite the lens with the housing therebetween, and heat generated by the imager and the imager board is also transferred to the housing. Therefore, regarding the infrared irradiation unit, heat transfer to the imager and the imager board is also required to be taken into consideration.

To ensure thermal lifetime of elements included in the imager and the imager board, irradiation output of infrared light cannot be increased and the dark-field visibility range becomes difficult to increase. Moreover, an amount of generated heat increases in accompaniment with a higher pixel count in the imager. Consequently, an issue arises in that a higher pixel count and a greater dark-field visibility range cannot both be obtained.

Here, the infrared irradiation unit is provided for imaging in a dark-field, or to suppress lens fogging and de-ice the lens. However, the issue above is not limited to the infrared irradiation unit and similarly arises in cases in which other electromagnetic wave generators are used. In addition, here, the camera apparatus is given as an example of the sensor apparatus. A higher pixel count and a greater dark-field visibility range are given as examples regarding the issue of obtaining both sensing performance and sensing range.

However, such an issue is not limited to the camera apparatus and similarly arises in other sensor apparatuses. For example, a millimeter-wave radar can be given as the sensor apparatus. In the millimeter-wave radar as well, de-icing can be performed by the electromagnetic wave generator being provided. However, obtaining both sensing performance and sensing range is difficult due to increase in the amount of generated heat resulting from enhanced functionality in sensing performance and heat generation resulting from the electromagnetic wave generator outputting electromagnetic waves.

It is thus desired to provide a sensor apparatus that is capable of obtaining both sensing performance and sensing range.

An exemplary embodiment of the present disclosure provides a sensor apparatus that includes a housing container; an electromagnetic wave generator that is housed in the housing container, outputs an electromagnetic wave outside the housing container, and generates heat in accompaniment with generating the electromagnetic wave; an electromagnetic wave transmission component that is housed in the housing container, configures an electromagnetic wave reception opening that receives the electromagnetic wave reflected by an object outside the housing container, and transmits the electromagnetic wave; a sensing element that is disposed further toward an inner side of the housing container than the electromagnetic wave transmission component is; a control board that is disposed further toward an inner side of the housing container than the electromagnetic wave transmission component, controls the sensing element is, and switches between the electromagnetic wave generator outputting the electromagnetic wave and the electromagnetic wave generator not outputting the electromagnetic wave; a housing that is disposed between the electromagnetic wave transmission component and the sensing element and the control board, and configures a path guiding the electromagnetic wave transmitted through the electromagnetic wave transmission component to the sensing element; and a fixing portion that is configured as a separate member from the housing and fixes the electromagnetic wave transmission component to the housing. The electromagnetic wave generator generates heat during output of the electromagnetic wave and the heat is transferred to the electromagnetic wave transmission component through the fixing portion.

In this manner, heat is generated by the electromagnetic wave generator outputting the electromagnetic wave. As a result of the heat being transferred to the electromagnetic wave transmission component, defogging and de-icing can be performed. At this time, a heat transfer path is such that the heat is transferred from the electromagnetic wave generator to the fixing portion and then to the electromagnetic wave transmission component. In addition, the fixing portion is provided as a separate member from the housing and is structured such that heat is transferred from the electromagnetic wave generator to the housing through the fixing portion. Therefore, to the extent that heat transfer is performed through a separate member, thermal resistance becomes greater than when the heat is directly transferred to the housing from the electromagnetic wave generator, and the heat is not easily transferred. Therefore, excessive temperature rise in the sensing element and the control board can be suppressed. In addition, as a result of temperature rise in the sensing element and the control board being suppressed, thermal lifespan of the sensing element and elements provided on the control board can be more easily ensured. Consequently, a greater output of electromagnetic waves from the electromagnetic wave generator and higher functionality of the sensing element can be obtained. Both sensing performance and sensing distance can be obtained.

Here, reference numbers in parentheses attached to the constituent elements and the like indicate examples of corresponding relationships between the constituent elements and the like and specific constituent elements and the like described according to the embodiments described hereafter.

Embodiments of the present disclosure will hereinafter be described with reference to the drawings. Here, sections according to the embodiments described below that are identical or equivalent to each other are described using the same reference numbers.

### First Embodiment

A first embodiment of the present disclosure will be described. According to the present embodiment, a camera apparatus is described as an example of a sensor apparatus. For example, the camera apparatus is to be mounted in a vehicle and used to capture images to ascertain a state surrounding the vehicle.

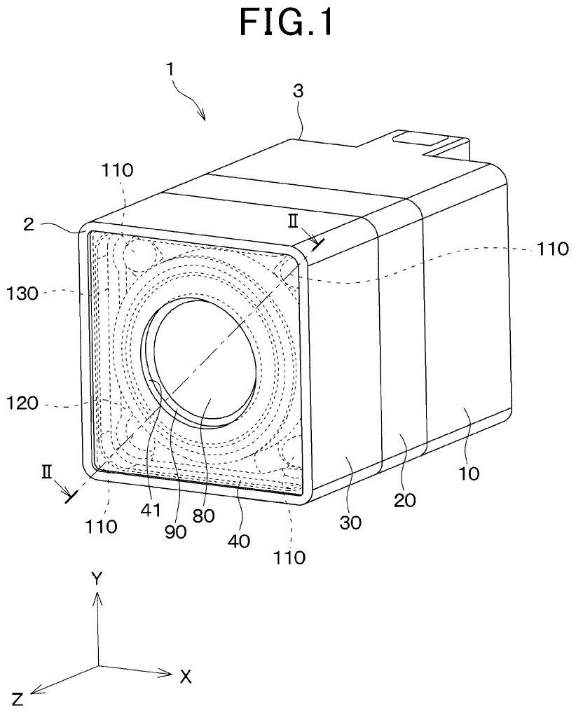

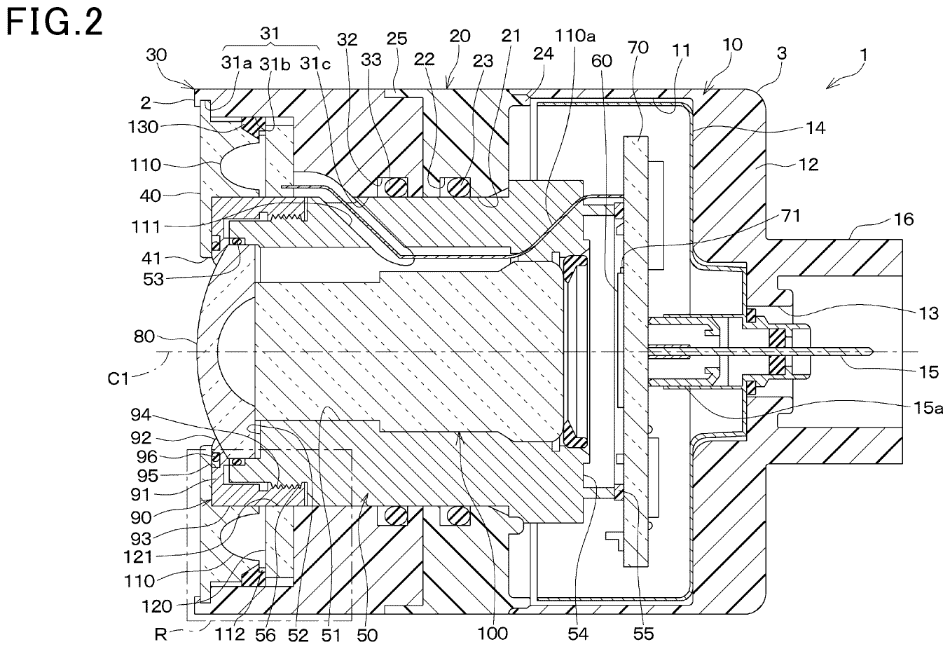

For convenience, an X-axis, a Y-axis, and a Z-axis are shown in the drawings attached to the present specification. As shown in FIG. 1, one direction on a tip end surface of the camera apparatus 1 and a direction orthogonal thereto are respectively referred to as the X-axis and the Y-axis. A direction orthogonal to both the X-axis and the Y-axis is referred to as the Z-axis. In addition, in the Z-axis direction, an end portion 2 on a side of the camera apparatus 1 on which imaging is performed is referred to as a tip end and an end portion 3 on a side opposite the tip end is referred to as a rear end. FIG. 2 corresponds to a cross-sectional view of the camera apparatus 1 taken along line II-II in FIG. 1, that is, along a line inclined at 45° relative to both the X-axis and the Y-axis in the Z-axis direction.

As shown in FIG. 1 to FIG. 3, the camera apparatus 1 includes a cover 10, a case 20, a head 30, a guide 40, a lens barrel 50, an imager 60, an imager board 70, a lens 80, a lens fixing portion 90, an optical component 100, an infrared irradiating unit 110, a light emission diode (LED) board 120, a rubber gasket 130, and the like.

The cover 10 configures a portion of a housing container of the camera apparatus 1, namely a portion of the housing container on the rear end 3 side positioned on a side opposite the tip end 2 side on which the guide 40 is disposed. The cover 10 is formed into a bottomed, substantially quadrangular cylindrical shape that has a quadrangular outer shape composed of two sides along the X-axis and two sides along the Y-axis when viewed from the Z-axis direction, and a hollow portion 11 inside that is formed by one surface side on the case 20 side being open. Although the cover 10 may be composed of an arbitrary material, for example, resin may be used. An opening portion 13 is formed in a center portion of a bottom portion 12 of the cover 10. In addition, inside the hollow portion 11, a shield portion 14 is disposed along an inner wall surface of the cover 10. In addition, the shield portion 14 and a terminal 15 are partially fitted into the opening portion 13, and the terminal 15 protrudes outside the cover 10. Furthermore, a connector 16 is formed protruding outside the camera apparatus 1 from the bottom portion 12 of the cover 10. As a result of the connector 16 being connected to another connector (not shown), power supply to the camera apparatus 1 and external output of image data captured by the camera apparatus 1 are performed.

A portion of the lens barrel 50, the imager 60, and the imager board 70 are housed inside the hollow portion 11 of the cover 10. The shield portion 14 surrounds the imager 60 and the imager board 70, and suppresses transmission of external noise to the imager 60 and the imager board 70.

The case 20 configures a portion of the housing container of the camera apparatus 1. The case 20 is formed into a substantially quadrangular cylindrical shape that has a quadrangular outer shape composed of two sides along the X-axis and two sides along the Y-axis when viewed from the Z-axis direction, and a hollow portion 21 passing through therein along the Z-axis. Although the case 20 may be composed of an arbitrary material, for example, resin may be used. The case 20 houses a portion of the lens barrel 50 and a portion of the optical component 100 inside the hollow portion 21. An annular groove 22 is formed on an inner wall of the case 20 and an O-ring 23 is fitted into the groove 22. The O-ring 23 comes into contact with an outer wall surface of the lens barrel 50, forming a seal between the case 20 and the lens barrel 50.

An engagement protrusion 24 that has a slightly smaller outer dimension than other portions is formed in an end portion of the case 20 on the cover 10 side. The case 20 and the cover 10 are integrated by the engagement protrusion 24 being fitted inside the hollow portion 11 of the cover 10. The outer shapes of the case 20 and the cover 10, that is, outer dimensions of the substantially quadrangular shapes coincide. Respective surfaces that form the sides of the substantially quadrangular shapes constitute same planes. In addition, as a result of a boundary position between the case 20 and the cover 10 being welded, the case 20 and the cover 10 are coupled in a state of close contact. Here, the coupling may be obtained not only by welding but other ways such as adhesion, press-fitting, and the like.

In addition, an engagement protrusion 25 is formed on an end portion of the case 20 on the head 30 side as well. The case 20 and the head 30 are integrated and fixed by the engagement protrusion 25 being fitted into an end portion of the head 30, described hereafter, on the case 20 side. Outer shapes of the case 20 and the head 30, that is, outer dimensions of the substantially quadrangular shapes coincide. Respective surfaces that form the sides of the substantially quadrangular shapes constitute same planes. Therefore, the surfaces of the cover 10, the case 20, and the head 30 constitute the same planes. A shape of the overall housing container of the camera 1 composed of the cover 10, the case 20, and the head 30 is a substantially rectangular shape.

Here, the case 20 and the head 30 are coupled by being fitted together. However, a boundary position between the case 20 and the head 30 may be welded. Of course, in addition to welding, other ways such as adhesion and press-fitting may be used.

The head 30 configures a portion of the housing container of the camera apparatus 1. The head 30 is formed into a substantially quadrangular cylindrical shape that has a quadrangular outer shape composed of two sides along the X-axis and two sides along the Y-axis when viewed from the Z-axis direction, and a hollow portion 31 passing through therein along the Z-axis. Although the head 30 may be composed of an arbitrary material, for example, metal may be used. The head 30 houses a portion of the lens barrel 50, a portion of the optical component 100, the lens 80, the infrared emitting unit 110, the LED board 120, the lens fixing portion 90, the rubber gasket 130, and the like in the hollow portion 31. An annular groove 32 is formed on an inner wall of the head 30 and an O-ring 33 is fitted into the groove 32. The O-ring 33 comes into contact with the outer wall surface of the lens barrel 50, forming a seal between the head 30 and the lens barrel 50. In addition, the guide 40 is disposed in the end portion 2 of the head 30 on the tip end side of the camera apparatus 1 such as to be fitted into the hollow portion 31. Infiltration of water into the hollow portion 31 is suppressed by the guide 40, the lens 80, and the lens fixing portion 90 including an O-ring 96 described hereafter.

The hollow portion 31 of the head 30 is formed into a shape that has a plurality of steps from the tip end 2 side toward the rear end 3 side along the Z-axis. Therefore, dimensions of the hollow portion 31, that is, inner wall dimensions of the head 30 change in steps. Specifically, the dimensions of the hollow portion 31 are such that a first portion 31a on an outermost tip end side coincide with outer dimensions of the guide 40. Then, the inner wall dimensions decrease from the first portion 31a in a second portion 31b that is further toward the rear end 3 side than the first portion 31a is. Then, with a boundary portion between the first portion 31a and the second portion 31b as a seating surface, the guide 40 is fitted into the hollow portion 31 and placed in close contact using an adhesive or the like. Furthermore, the inner dimensions of the hollow portion 31 further decrease in a third portion 31c that is further toward the rear end 3 side than the second portion 31b is, and coincide with outer shapes of the lens barrel 50 and the lens fixing portion 90. In addition, with a boundary position between the second portion 31b and the third portion 31c as a mounting surface, the LED board 120, the infrared irradiating unit 110, and the rubber gasket 130 are disposed inside the hollow portion 31. Furthermore, a portion of the lens barrel 50, a portion of the lens fixing portion 90, and a portion of the optical component 100 are disposed inside the third portion 31c.

The guide 40 is a plate-shaped component that protects functional components of the camera apparatus 1 and is composed of glass, acrylic resin, or the like. The guide 40 has a quadrangular outer shape composed of two sides along the X-axis and two sides along the Y-axis. The guide 40 prevents infiltration of water into the camera apparatus 1, together with the lens 80 and the lens fixing portion 90, by being attached to the head 30. An opening portion 41 is formed in a center of the guide 40. A portion of the lens 80 and the lens fitting portion 90 are exposed from the opening portion 41.

The lens barrel 50 corresponds to a housing that directs light received by the lens 80 to the imager 60. The lens barrel 50 is configured to have a cylindrical shape, or in this case, a substantially circular cylindrical shape, having a hollow portion 51 passing through in the Z-axis direction. The lens barrel 50 may be, for example, composed of metal. An optical axis of the lens barrel 50 runs in a direction along the Z-axis, or in this case, parallel to the Z-axis.

The lens barrel 50 holds the lens 80 and the other optical component 100 to obtain a desired positional relationship, that is, a positional relationship in which light is condensed in a location in which the imager 60 is disposed. Specifically, a plurality of optical components 1000 are disposed along the Z-axis in the hollow portion 51 of the lens barrel 50 and held on an inner wall surface of the lens barrel 50. In addition, a lens housing portion 52 is formed on the tip end 2 side of the lens barrel 50. The lens housing portion 52 recesses from the tip end 2 side toward the rear end 3 side and is formed such that inner wall dimensions of the lens barrel 50 are increased from that in a section in which the optical components 100 are disposed. As a result of the lens 80 being disposed inside the lens housing portion 52, the lens 80 comes into contact with the tip end of the lens barrel 50. Here, an O-ring 53 is disposed in a portion of the lens housing portion 52 of the lens barrel 50 positioned on an outer periphery of the lens 80, forming a seal between the lens 80 and the lens barrel 50. In addition, positioning of the lens 80 in an XY-plane direction is thereby performed.

Moreover, a recessing portion 54 in which the imager 60 is disposed is formed on the rear end 3 side of the lens barrel 50, and further, the rear end 3 side of the lens barrel 50 is coupled with the imager board 70 with an adhesive material 55 therebetween. Therefore, a positional relationship of the lens 80 and the optical components 100 to the imager 60 is a desired positional relationship. Light received through the lens 80 is inputted to the imager 60 such that a focal point of the light is aligned.

In addition, because the lens barrel 50 and the imager board 70 are coupled, during use of the camera apparatus 1, heat generated by the imager 60 and the imager board 70 is transmitted to the lens barrel 50 side.

The imager 60, or in other words, an image sensor, is a sensing element and configured by a complementary metal-oxide semiconductor (CMOS), a charge-coupled device (CCD), or the like. The imager 60 is disposed further toward the inner side of the housing container than the lens 80 is and configures an imaging unit that receives light through the lens 80 and the optical components 100, and captures an image of an object appearing in the lens 80. To improve sensing performance, a high pixel-count imager 60 is used.

The imager board 70 is a substrate on which an electronic control unit (ECU) including electronic components such as various elements driving the imager 60 is mounted. The imager board 70 performs on/off control of the infrared irradiating unit 110, that is, switching between infrared light being outputted and infrared light not outputted, in addition to control of the imager 60. The imager board 70 is disposed further toward the inner side of the housing container than the lens 80 is, together with the imager 60. The imager board 70 is a substrate formed into a substantially quadrangular plate shape having two sides along the X-axis and two sides along the Y-axis. The imager 60 is mounted on a front surface, that is, one surface on the tip end 2 side of the imager board 70. Because the lens barrel 50 and the imager board 70 are coupled, during use of the camera apparatus 1, heat generated by the imager 60 and the various elements provided on the imager board 70 are transferred to the lens barrel 50.

The imager board 70 further includes a temperature sensor 71. The temperature sensor 71 detects a temperature of the imager 60 and the various elements provided on the imager board 70. The temperature is used to adjust light emission timing of the infrared irradiating unit 110. Here, in the description below, the temperature detected by the temperature sensor 71 is referred to as a first temperature.

The terminal 15 is connected to the imager board 70 on another surface side that is on a side opposite the imager 60. The terminal 15 enables power supply to the imager 60 and the various elements provided on the imager board 70, and output of image data captured by the imager 60. Specifically, a terminal support member 15a is connected to the other surface side of the imager board 70 and the terminal 15 is fitted into the terminal support member 15a. Furthermore, the terminal 15 protrudes outside the cover 10 from the opening portion 13 in the cover 10.

The lens 80 is configured by a convex lens of which a center protrudes toward the tip end 2 side relative to an outer edge portion. The lens 80 is disposed in the tip end of the lens barrel 50. For example, the lens 80 may be composed of glass and may be a material having a lower heat transfer coefficient than the material of the lens barrel 50. The convex surface on the front side of the lens 80 is exposed from the opening portion 41 of the guide 40 and receives light from outside the camera apparatus 1 through the opening portion 41.

The lens fixing portion 90 is a member that fixes the lens 80 to the tip end of the lens barrel 50. The lens fixing portion 90 is composed of a material that easily transfers heat to the lens 80. Here, the lens fixing portion 90 is composed of metal. As described above, the lens 80 is composed of a material having a lower heat transfer coefficient than the material of the lens barrel 50. Therefore, heat transfer to the lens barrel 50 through the lens 80 is further suppressed than heat transfer to the lens barrel 50 through the lens fixing portion 90.

The lens fixing portion 90 is configured to have a bottomed, circular cylindrical shape, and structured such that a circular opening portion 92 is formed in a center of a bottom portion 91, and the outer periphery of the lens 80 is in contact with a portion of the bottom portion 91 positioned in the periphery of the opening portion 92. The portion of the bottom portion 91 positioned in the periphery of the opening portion 92 is an inner wall surface that is a curved surface matching the shape of the lens 80 or having a circular conical shape, and presses the lens 80 towards the lens barrel 50 side while being in close contact with the lens 80.

Specifically, a female screw thread 94 is formed in an inner wall surface of a circular cylindrical portion 93 of the lens fixing portion 90. A male screw thread 96 is formed in the outer peripheral surface on the tip end side of the lens barrel 50. When the lens fixing portion 90 is rotated while being fitted into the tip end of the lens barrel 50 with the lens 80 set in the tip end of the lens barrel 50, the female screw thread 94 and the male screw thread 56 engage, and the lens fixing portion 90 is fixed to the tip end on the lens 80 side of the lens barrel 50. As a result, the lens 80 is fixed such as to be sandwiched between the lens fixing portion 90 and the tip end of the lens barrel 50.

More specifically, a dimension in the Z-axis direction of the circular cylindrical portion 93 of the lens fixing portion 90 is such that the rear end 3 side of the circular cylindrical portion 93 is positioned further toward the imager board 70 side than the LED board 120 side is. Therefore, the lens barrel 50 and the LED board 120 are not in direct contact and the circular cylindrical portion 93 of the lens fixing portion 90 is interposed therebetween.

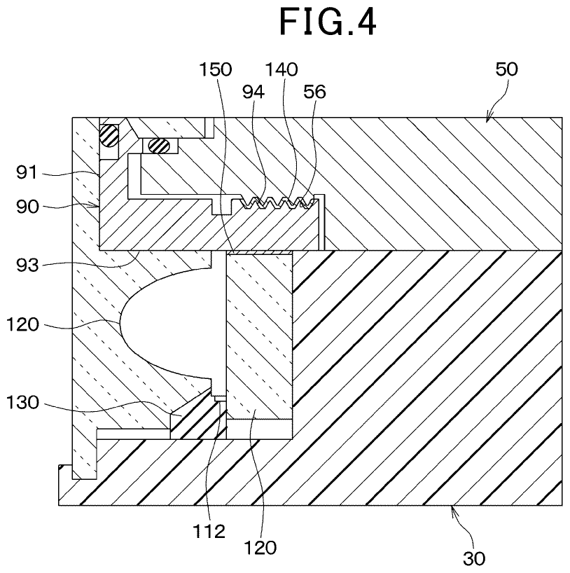

In addition, as shown in FIG. 4, a low thermal-conductivity member 140 is disposed in a portion positioned on the inner side of the LED board 120 of an area sandwiched between the lens fixing portion 90 and the lens barrel 50, that is, between the circular cylindrical portion 93 and the lens barrel 50. The low thermal-conductivity member 140 is preferably also disposed between the end portion on the rearmost end 3 side of the circular cylindrical portion 93 and the lens barrel 50 but may not be provided. When the low thermal-conductivity member 140 is not disposed between the end portion on the rearmost end 3 side of the circular cylindrical portion 93 and the lens barrel 50, a gap is preferably formed therebetween.

The low thermal-conductivity member 140 is composed of a material having low thermal conductivity. The low thermal-conductivity member 140 is merely required to be composed of a material that less easily transfers heat than when the lens fixing portion 90 is in direct contact with the lens barrel 50, but is preferably a material having lower thermal conductivity. For example, the low thermal-conductivity member 140 may be formed by a resin such as a resin-based adhesive being applied to either of the female screw thread 94 and the male screw thread 56.

Here, an annular groove 95 is formed on one surface of the lens fixing portion 90 on the guide 40 side, that is, the side opposing the guide 40. An O-ring 96 is fitted into the groove 95. As a result, a seal is formed between the opening portion 41 of the guide 40 and the outer peripheral side of the lens fixing portion 90, that is, the side on which the infrared irradiating unit 110 is disposed. Water-proofing of the infrared irradiating unit 110 is obtained.

The optical component 100 is disposed inside the hollow portion 51 of the lens barrel 50 further toward the imager 60 side than the lens 80 is. A plurality of optical components 100 are provided according to the present embodiment and are composed of various types of lenses and the like. As a result of the lens 80 and the optical components 100, light that is received is condensed and inputted to the imager 60. Arrangement, quantity, and size of the optical components 100 are arbitrary but set such that the received light can be condensed and inputted to the imager 60.

The infrared irradiating unit 110 is an electromagnetic wave generator and outputs infrared light, which is an electromagnetic wave, outside the housing container. For example, the infrared irradiating unit 110 may be configured by a semiconductor light source such as an infrared LED, a vertical-cavity surface-emitting laser (VCSEL), or a photonic crystal surface-emitting laser (PCSEL). Here, the infrared irradiating unit 110 is configured by the infrared LED. The infrared LED has a substantially semispherical shape in which a side that irradiates infrared light is spherical and a side opposite is planar. Wiring or a pad (not shown) is formed on the planar side. In addition, the planar side of the infrared LED is directly mounted onto a surface of the LED board 120. Here, the infrared irradiating unit 110 is configured by the infrared LED. However, in cases in which the infrared irradiating unit 110 is configured by the VCSEL or the PCSEL as well, the configuration may be such that the VCSEL or the PCSEL is directly mounted onto a surface of the LED board 120.

The infrared irradiating unit 110 is disposed adjacent to the lens 80 and irradiates the infrared light outside the camera apparatus 1 as the electromagnetic waves. As a result, when the vicinity of the camera apparatus 1 is dark, dark-field visibility can be obtained by the infrared light being irradiated outside the camera apparatus 1 and the reflected light of the infrared light being received with the lens 80 as a receiving unit. In addition, the infrared irradiating unit 110 generates heat by generating light. The heat is transferred to the lens fixing portion 90 either directly or through the LED board 120, and further transferred to the lens 80. Therefore, when the lens 80 is fogged or frozen, defogging and de-icing of the lens 80 can be performed by the infrared irradiating unit 110 generating light regardless of whether or not the vicinity of the camera apparatus 10 is dark.

The infrared irradiating unit 110 is provided in each of the four corners of the camera apparatus 1 that has a quadrangular shape when viewed in the Z-axis direction. An optical axis of each infrared irradiating unit 110 is arbitrary as long as the infrared light can be irradiated within an imaging range of the camera apparatus 1. However, the optical axis of each infrared irradiating unit 110 being inclined relative to the optical axis of the lens barrel 50, that is, a straight line C1 indicated by a single-dot chain line in FIG. 2 according to the present embodiment is preferable since the reflected light of the infrared light being incident on the lens 80 at an excessively high intensity can be suppressed. When the imaging range assumed for the camera apparatus 1 is a predetermined range with the straight line C1 that serves as the optical axis of the lens barrel 50 at the center, the optical axis L of the infrared irradiating unit 110 is inclined relative to the straight line C1.

Alternatively, the optical axes of the infrared irradiating units 110 disposed on a diagonal line, among the four infrared irradiating units 110, are inclined in opposite directions from each other relative to the straight line C1. When the assumed imaging range is equal to or greater than 100° with the straight line C1 at the center, the optical axes of the infrared irradiating units 110 are inclined such that a total irradiation range that can be covered by adjacent infrared irradiating units 110 is equal to or greater than 100°. As shown in FIG. 5, when the infrared irradiating unit 110 is oriented at 60°, a 60° irradiation range of one infrared irradiating unit 110 and a 60° irradiation range of the other infrared irradiating unit 110 are overlapped such that the total irradiation range is 100°. As a result, the infrared light can be irradiated over a wider range and imaging can be performed over a wider range.

Energization wiring 110a for energizing the infrared irradiating unit 110 is electrically connected to the imager board 70 through a through hole 111 formed in the lens barrel 50 or the like. Although not shown, the energization wiring 110a is covered by a resin or the like and insulated from the lens barrel 50. The ECU provided on the imager board 70 controls energization of the infrared irradiating unit 110 through the energization wiring 110a.

In addition, a temperature sensor 112 is provided adjacent to the infrared irradiating unit 110 or on a side surface of the infrared irradiating unit 110. The temperature sensor 112 detects a temperature of the infrared irradiating unit 110 and transmits the detection result to the imager board 70. The detected temperature is then used to adjust a light generation timing of the infrared irradiating unit 110. Here, in the description below, the temperature detected by the temperature sensor 112 is referred to as a second temperature.

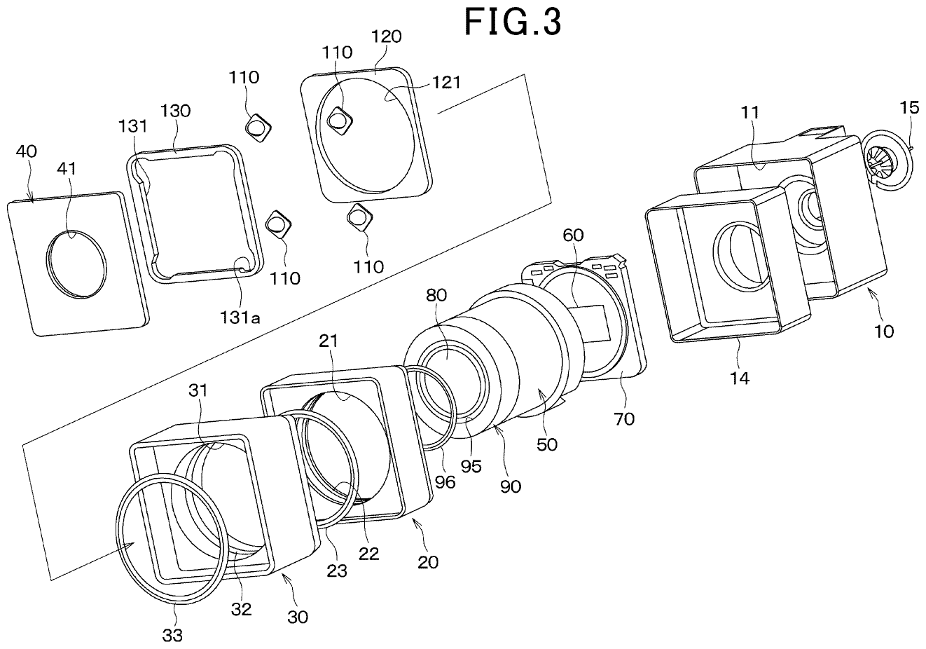

The LED board 120 is a mounting board that serves as a mount on which the infrared irradiating unit 110 is held. According to the present embodiment, the infrared irradiating unit 110 is directly mounted into the LED board 120. As shown in FIG. 3, the LED board 120 has a quadrangular frame shape and a center portion is a circular opening portion 121. A diameter size of the opening portion 121 coincides with an outer diameter size of the lens fixing portion 90, and the lens fixing portion 90 is inserted into the opening portion 121.

As described above, heat generated by the infrared irradiating unit 110 is transferred to the lens 80 from the LED board 120 through the lens fixing portion 90. To enable the heat transfer to be favorably performed, as shown in FIG. 4, a high thermal-conductivity member 150 is disposed between the LED board 120 and the lens fixing portion 90.

The high thermal-conductivity member 150 is composed of a material having high thermal conductivity that is at least a material having higher thermal conductivity than the low thermal-conductivity member 140. The high thermal-conductivity member 150 is merely required to be composed of a material that more easily transfers heat than when the lens fixing portion 90 is in direct contact with the lens barrel 50, but is preferably a material having higher thermal conductivity. For example, the LED board 120 may be connected to the lens fixing portion 90 by a high thermal-conductivity adhesive or the like and the high thermal-conductivity member 150 may be composed of the high thermal-conductivity adjustive. As the high thermal-conductivity member 150, either of a non-electrically conductive member and an electrically conductive member is applicable. However, a non-electrically conductive member is preferably used since electrical leakage can be suppressed.

The rubber gasket 130 is a member that is sandwiched between the guide 40 and the head 30, and suppresses infiltration of water between the guide 40 and the head 30. The rubber gasket 130 is formed having a quadrangular frame shape that has a hollow portion 131. Four corners of the hollow portion 131 are circular holes 131a having a substantially circular shape formed by the corners being rounded to follow the shape of the infrared irradiating unit 110. Outer dimensions of the rubber gasket 130 are greater than inner dimensions of the head 30. Dimensions of the hollow portion 131 are smaller than outer dimensions of the guide 40. As a result, a gap between the guide 40 and the head 30 is covered and sealed. The camera apparatus 1 according to the present embodiment is configured in the manner described above.

### Operation of the Camera Apparatus

Next, an operation of the camera apparatus 1 configured as described above will be described. When the camera apparatus 1 is to be used such as to be mounted in a vehicle, the camera apparatus 1 is applied for use in capturing images to ascertain a state surrounding the vehicle. For example, an operation timing of the camera apparatus 1 may be during traveling of the vehicle or during parking assistance of the vehicle. The imager 60 captures images during these periods.

Specifically, the ECU provided on the imager board 70 controls image capturing by the imager 60, and the image data captured by the camera apparatus 1 is outputted outside through the terminal 15. Then, the ECU provided on the imager board 70 or an ECU outside the camera apparatus 1 analyzes the camera data.

At this time, in a state in which the vicinity of the camera apparatus 1 is bright such as during daytime, the image data has sufficient luminance. Therefore, the imager 60 captures images without the infrared irradiating unit 110 generating light. However, the lens 80 being fogged or frozen may be assumed through analysis of the image data. In such cases, the infrared irradiating unit 110 generates heat by generating light. As a result, the heat generated by the infrared irradiating unit 110 is transferred to the lens fixing portion 90 either directly or through the LED board 120, and further transferred to the lens 80. Therefore, when the lens 80 is fogged or frozen, defogging or de-icing of the lens 80 can be performed by the infrared irradiating unit 110 generating light even should the vicinity of the camera apparatus 1 be bright.

In addition, in a state in which the vicinity of the camera apparatus 1 is dark such as during nighttime, the image data does not have sufficient luminance. Therefore, the imager 60 captures images by the infrared irradiating unit 110 generating light and the reflected light of the infrared light from an object present in the vicinity of the camera apparatus 1 being received. As a result, defined image data can be acquired even at night.

Furthermore, when the infrared irradiating unit 110 generates light, the temperature sensor 71 and the temperature sensor 112 sense the first temperature and the second temperature. Based on the first temperature and the second temperature, the ECU provided on the imager board 70 automatically adjusts the light generation timing of the infrared irradiating unit 110.

For example, a period during which an amount of inputted light is small and the vicinity of the camera apparatus 1 is dark, or the lens 80 is assumed to be fogged or frozen based on imaging data is a period during which light generation is required. Therefore, with this period as a light generation-required period, the infrared irradiating unit 110 generates light during the light generation-required period. During the light generation-required period, light generation is unrestricted and the infrared irradiating unit 110 generates light continuously without interruption in terms of time, until the first temperature and the second temperature exceed respectively prescribed predetermined thresholds. Then, when either or both the first temperature and the second temperature exceed the predetermined thresholds, the light generation of the infrared irradiating unit 110 is restricted compared to that before the predetermined thresholds are exceeded. For example, during the light generation-required period, an intermittent operation in which the infrared irradiating units 110 intermittently generate light or a selective operation in which the infrared irradiating units 110 selectively generate light is performed.

In the intermittent operation, while all infrared irradiating units 110 simultaneously irradiate infrared light, the irradiation is performed intermittently, the time interval between image acquisition is extended, and the number of frames is reduced. In the selective operation, only a portion of the plurality of infrared irradiating units 110, such as two of the four infrared irradiating units 110, irradiates light. The infrared irradiating units 110 that generate light are preferably periodically changed. As a result of the light generation by the infrared irradiating units 110 being restricted in this manner, overheating of the imager board 70 as a result of heat transfer from the infrared irradiating units 110 can be suppressed. Either of the intermittent operation and the selective operation may be performed, or the intermittent operation and the selective operation may be performed in combination. For example, the intermittent operation and the selective operation may be performed in combination by the operation in which two of the four infrared irradiating units 110 irradiate infrared right being intermittently performed.

### Workings and Effects of the Camera Apparatus 1

In the camera apparatus 1 of the present disclosure described above, the infrared irradiating unit 110 generates heat by generating light and the heat is transferred to the lens 80. As a result, defogging and de-icing of the lens 80 can be performed. At this time, a heat transfer path is such that the heat is transferred from the infrared irradiating unit 110 to the lens fixing portion 90 either directly or through the LED board 120, and then transferred to the lens 80. In addition, the heat is transferred from the infrared irradiating unit 110 to the lens barrel 80 connected to the imager board 70 via the lens fixing portion 90, rather than directly or through the LED board 120.

In this manner, the structure is such that the lens fixing portion 90 that fixes the lens 80 to the lens barrel 50 is provided as a separate member from the lens barrel 50, and the heat is transferred from the infrared irradiating unit 110 to the lens barrel 50 through the lens fixing portion 90. Therefore, to the extent that heat transfer is performed through a separate member, thermal resistance becomes greater than when the heat is transferred to the lens barrel 50 directly from the infrared irradiating unit 110 or through the LED board 120, and the heat is not easily transferred. Therefore, excessive temperature rise in the imager 60 and the imager board 70 can be suppressed. In addition, as a result of temperature rise in the imager 60 and the imager board 70 being suppressed, thermal lifespan of the imager 60 and the elements provided on the imager board 70 can be more easily ensured. Consequently, a greater irradiation output of the infrared irradiating unit 110 and a higher pixel count of the imager 60 can be obtained. Both a higher pixel count and a greater dark-field visibility range, that is, sensing performance and sensing distance can be obtained. Furthermore, because the lifespan of the electronic components can be extended, reliability of the camera apparatus 1 can be enhanced.

In addition, following effects are also obtained by the camera apparatus 1 of the present disclosure.

(1) The first temperature and the second temperature are sensed, and light generation by the infrared irradiating units 110 during the light generation-required period is automatically adjusted based on the temperatures. For example, heat generation by the infrared irradiating unit 110 may be suppressed by the infrared irradiating units 110 being intermittently operated or selectively operated during the light generation-required period. As a result, excessive temperature rise in the imager 60 and the imager board 70 can be suppressed. Both a higher pixel count and a greater dark-field visibility range can be further obtained.

In addition, the ECU provided on the imager board 70 may acquire vehicle speed information and control operation of the infrared irradiating units 110 based on the vehicle speed. The ECU provided in the imager board 70 can calculate the vehicle speed by analyzing image data or acquire the vehicle speed information from another external ECU or the like.

As the vehicle speed increases, an amount of time until the vehicle collides with an object present ahead in the advancing direction becomes shorter. Therefore, during high-speed travel, a longer visible distance and a shorter image acquisition time interval are required. Meanwhile, during low-speed travel in which the amount of time until a collision with an object is relatively long, there is some leeway in time until a driving assistance system that provides safety assistance to the vehicle performs operation to avoid danger. Therefore, in comparison to that during high-speed travel, the driving assistance system is minimally affected during low-speed travel even when the output of the infrared irradiating units 110 is relatively decreased. Therefore, for example, during low-speed travel when a wind speed of traveling airflow (wind) is low and a heat dissipation effect is reduced, the infrared irradiating units 110 are preferably intermittently operated or selectively operated. For example, a predetermined vehicle speed threshold may be set. When the vehicle speed is equal to or less than the vehicle speed threshold, a proportion of light generation by the infrared irradiating units 110 per unit time may be reduced by the intermittent operation or the selective operation, in comparison to when the vehicle speed is higher than the vehicle speed threshold.

(2) The infrared irradiating unit 110 is directly mounted onto the LED board 120. Therefore, heat transfer efficiency is increased compared to a case in which a member of some kind is interposed between the infrared irradiating unit 110 and the LED board 120. Therefore, because heat is more easily transferred to the lens 80 and the amount of light generated by the infrared irradiating unit 110 required to defog and de-ice the lens 80 can be reduced, a higher pixel count can be obtained in the imager 60.

Furthermore, the high thermal-conductivity member 150 is disposed between the LED board 120 and the lens fixing portion 90. Therefore, heat transfer efficiency from the LED board 120 to the lens fixing portion 90 is increased and the above-described effect is further obtained.

(3) The low thermal-conductivity member 140 is disposed between the lens barrel 50 and the lens fixing portion 90. Therefore, heat is not easily transferred from the lens fixing portion 90 to the lens barrel 50. Therefore, excessive temperature rise in the imager 60 and the imager board 70 is further suppressed and both a higher pixel count and a greater dark-field visibility range can be obtained.

(4) The optical axis of the infrared irradiating unit 110 is inclined in relation to the optical axis of the lens barrel 50. Therefore, the reflected light of the infrared light being incident on the lens 80 at an excessively high intensity can be suppressed. In addition, the infrared light can be irradiated over a wider range and imaging can be performed at a wider range.

### Second Embodiment

A second embodiment of the present disclosure will be described. According to the present embodiment, a preferred application example of the camera apparatus 1 will be described. A structure itself of the camera apparatus 1 is similar to that according to the first embodiment. Therefore, only the application example of the camera apparatus 1 will be described.

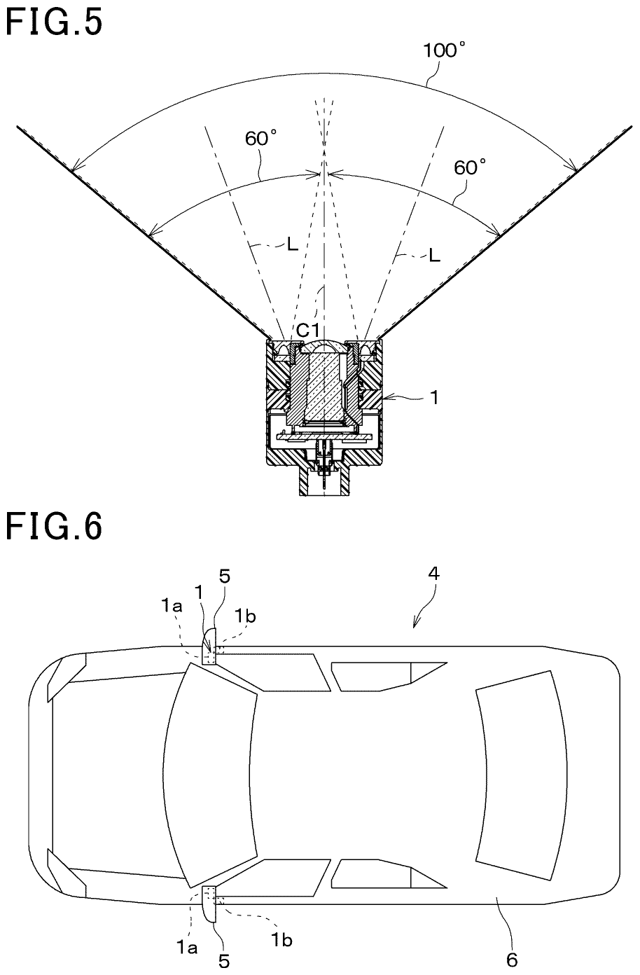

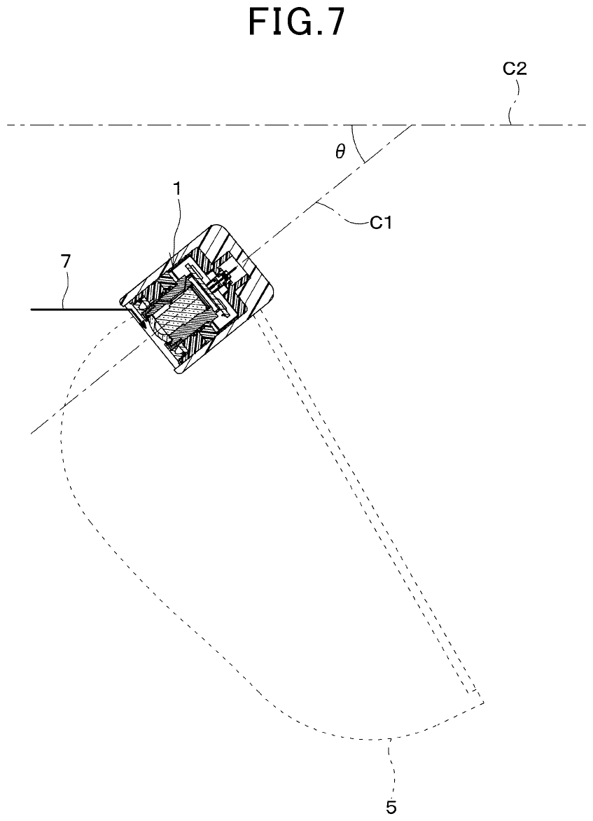

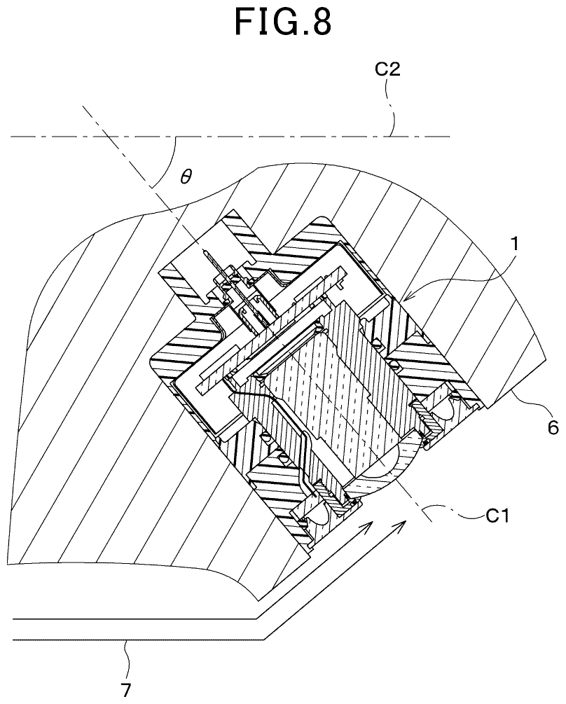

According to the present embodiment, as shown in FIG. 6, the camera apparatus 1 is applied for in-vehicle use. The camera apparatus 1 is set in a total of four locations on left and right sides of a vehicle 4 in two types of locations in the vehicle 4. Specifically, a camera apparatus 1a is set below a side mirror 5 of the vehicle 4 and a camera apparatus 1b is set in a front fender 60 to the rear of a front wheel. FIG. 7 and FIG. 8 show projection views of the locations in which the camera apparatuses 1 are attached, viewed from above, as well as cross-sectional views of the camera apparatuses 1. However, to facilitate understanding, in the cross-sectional view of the camera apparatus 1, the camera apparatus 1 is cut on a plane that runs along the Z-axis at an incline of 45° to the X-axis and the Y-axis in FIG. 1, in a manner similar to FIG. 2. In addition, for convenience, a position of the side mirror 5 is indicated by a dotted line in FIG. 7.

As shown in FIG. 7, the camera apparatus 1 set below the side mirror 5 is such that the straight line C1 that serves as the optical axis of the lens barrel 50 is inclined at a predetermined angle θ, such as an angle equal to or greater than 15°, to a straight line C2 along a longitudinal (front/rear) direction of the vehicle 4 to capture images obliquely ahead of the vehicle 4. Here, the straight line C1 that serves as the optical axis of the lens barrel 50 is parallel to a horizontal plane but may be inclined relative to the horizontal plane.

In addition, as shown in FIG. 8, the camera apparatus 1 set inside the front fender 6 is such that the straight line C1 that serves as the optical axis is inclined at the predetermined angle θ, such as an angle equal to or greater than 15°, to the straight line C2 to capture images obliquely behind the vehicle 4. Here, the straight line C1 that serves as the optical axis of the lens barrel 50 of the camera apparatus 1b is also parallel to the horizontal plane but may be inclined relative to the horizontal plane.

The predetermined angle θ herein may be arbitrary but preferably, for example, equal to or greater than 15° and equal to or less than 90°. That is, when the optical axis of the lens barrel 50 is inclined relative to the longitudinal direction of the vehicle 4, the guide 40 of the camera apparatus 1 is also inclined relative to the longitudinal direction of the vehicle 4. Therefore, as shown in FIG. 7 and FIG. 8, for example, traveling airflow 7 from ahead of the vehicle 4 flows along the surface of the guide 40 toward the lens 80 side, and can come into contact with the lens 80 after coming into contact with the lens fixing portion 90 through the opening portion 41 of the guide 40. In this manner, the structure is such that the lens fixing portion 90 is positioned upstream and the lens 80 is positioned downstream of the flow of the traveling airflow 7. As a result, the lens fixing portion 90 can be easily cooled and the lens 80 can be less easily cooled by receiving air that has been warmed by the lens fixing portion 90. Therefore, the lens 80 becoming fogged or frozen can be suppressed.

### Third Embodiment

A third embodiment of the present disclosure will be described. According to the present embodiment, a structure of a housing container and the like are modified from that according to the first embodiment. Other structures are similar to those according to the first embodiment. Therefore, only sections differing from that according to the first embodiment will be described.

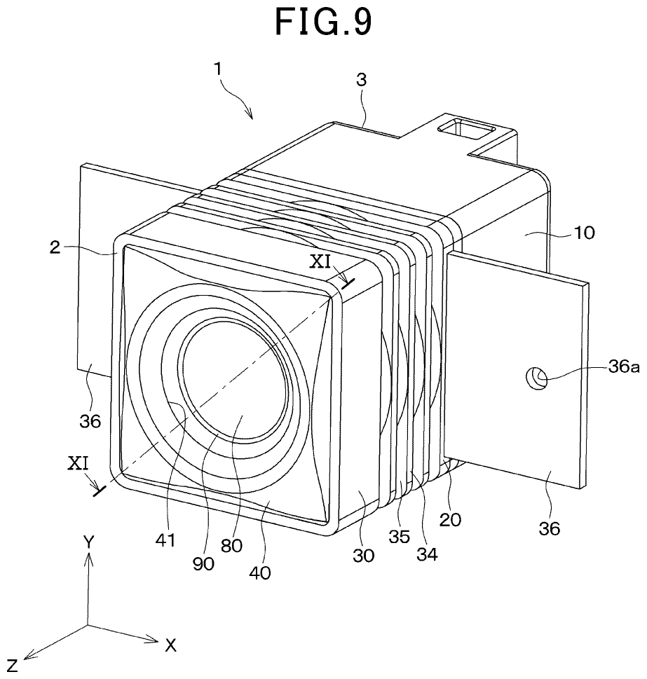

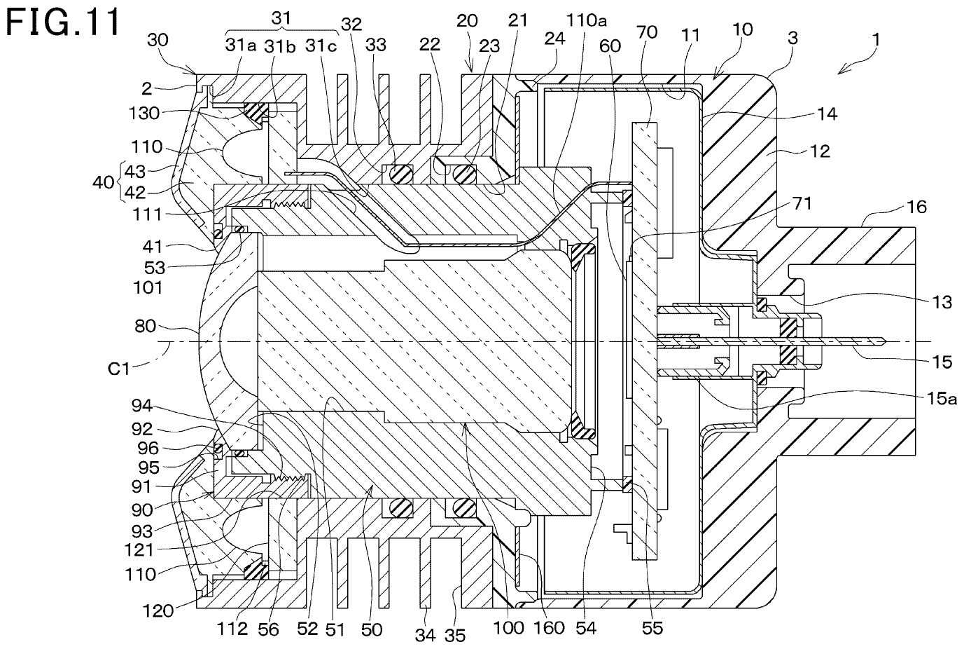

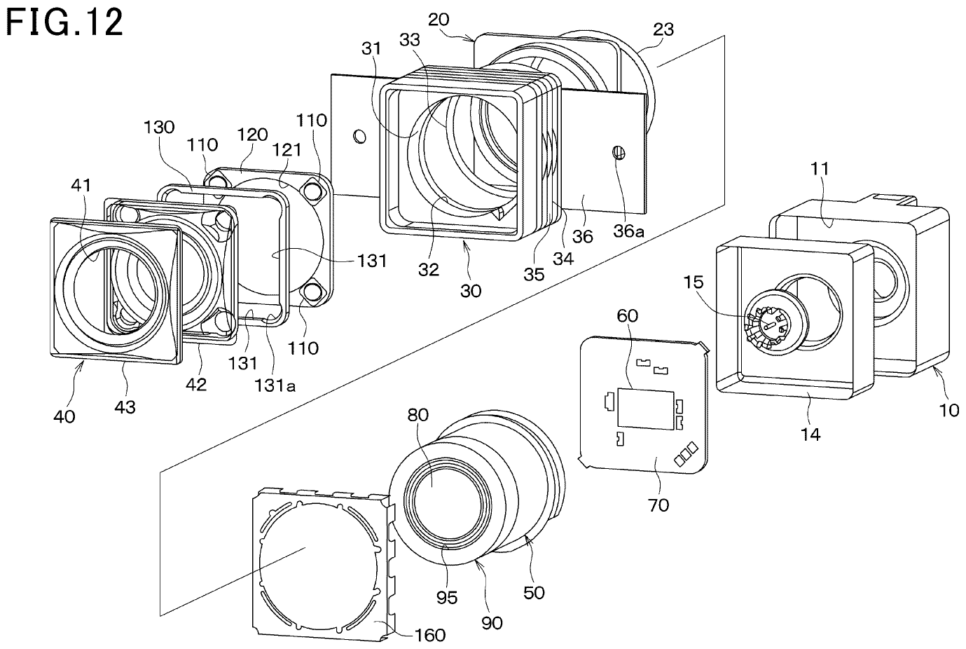

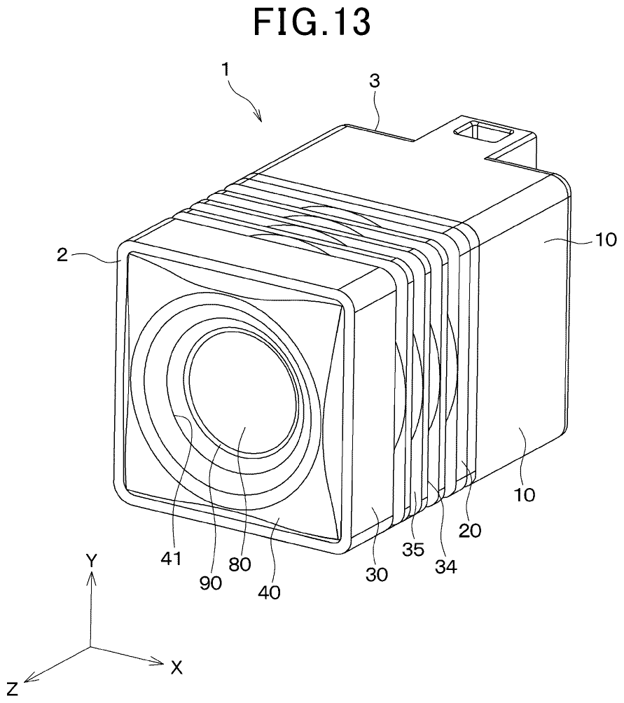

As shown in FIG. 9 to FIG. 12, according to the present embodiment, the head 30 has a heat dissipating structure. In addition, the head 30 is composed of metal that easily transfers heat. Specifically, a heat dissipation fin 34 is provided on an outer wall surface of the head 30. The heat dissipation fin 34 is a structure that widens in a circular shape in a radial direction with the lens barrel 50 at the center. The heat dissipation fin 34 is configured by a plurality of recessing portions 35 that recess in an inward radial direction being formed on the outer wall surface of the head 30.

In addition, an outer peripheral wall of the case 20 recesses further along the Z-axis direction than an inner peripheral wall is so that an area in which the heat dissipation fin 34 is disposed can be widened. Furthermore, an outer peripheral wall of the head 30 protrudes further along the straight line C1 than an inner peripheral wall is, and the head 30 is inserted into the recessing portion of the case 20.

As a result of the head 30 being provided with the heat dissipating structure in this manner, the lens barrel 50 can be cooled. Therefore, temperature rise in the imager 60 and the imager board 70 can be suppressed, and the thermal lifespan of the imager 60 and the elements provided on the imager board 70 can be more easily ensured. Both sensing performance and sensing range can be further obtained.

Moreover, according to the present embodiment, the head 30 has a bracket-integrated structure. Specifically, the head 30 has a quadrangular outer shape when viewed from the Z-axis direction, and a bracket 36 protrudes along the X-axis direction from two surfaces constituting the two sides of the quadrangular shape along the Y-axis direction. The bracket 36 is a component for attaching the camera apparatus 1 to a vehicle body of the vehicle 4 that serves as an attached member. For example, the camera apparatus 1 may be attached to the vehicle body such that a screw (not shown) is inserted into a hole 35a provided in the bracket 36.

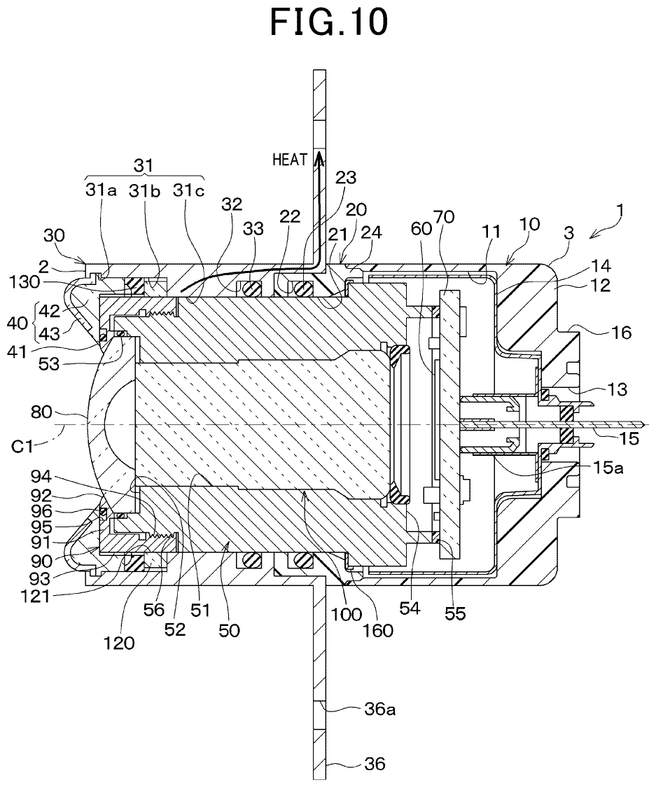

The head 30 can have a bracket-integrated structure in this manner. In this case, as indicated by an arrow in FIG. 10, the heat transferred from the infrared irradiating units 110 to the head 30 is transferred to the attaching member through the bracket 36. Therefore, the LED board 120 can be cooled. In particular, when the head 30 is composed of metal that easily conducts heat, the LED board 120 is more easily cooled. As a result of the bracket 36 such as this being provided, temperature rise in the imager 60 and the imager board 70 can be suppressed, and the lifespan of the imager 60 and the elements provided on the imager board 70 can be easily ensured. Therefore, both sensing performance and sensing range can be further obtained.

The heat dissipation fin 34 and the bracket 36 may be separate components from the head 30 and structured to be fixed to the periphery of the head 30. However, as a result of the head 30, the heat dissipation fin 34, and the bracket 36 being formed into a single component as according to the present embodiment, assembly can be improved, heat resistance can be reduced, and heat dissipation can be more favorably obtained in the LED board 120.

Here, as shown in FIG. 10 to FIG. 12, a grounding spring 160 composed of metal is provided in a boundary position between the cover 10 and the case 20. The grounding spring 160 can suppress wobble of the lens barrel 50 to the case 20, and suppress transmission of external noise to the imager 60 and the imager board 70. In addition, the guide 40 is divided into two members and configured by a first guide portion 42 that covers the infrared irradiating units 110 and a second guide portion 43 that covers a surface of the first guide portion 42. As a result of a configuration such as this, for example, the first guide portion 42 and the second guide portion 43 can serve differing purposes, such as the first guide portion 42 being composed of a material suitable for guiding light and the second guide portion 43 being composed of a highly durable material.

### Other Embodiments

While the present disclosure has been described with reference to the above-described embodiments, it is to be understood that the invention is not limited to these embodiments. The present disclosure is intended to cover various modification examples and modifications within the range of equivalency. In addition, various combinations and configurations, and further, other combinations and configurations including more, less, or only a single element thereof are also within the spirit and scope of the present disclosure.

(1) For example, the infrared irradiating unit 110 may be attached to the head 30 with the LED board 120 therebetween. However, the LED board 120 may not be provided. In this case, for example, the portion of the LED board 120 may be configured by the lens fixing portion 90 and integrated. Alternatively, the structure may be such that the infrared irradiating unit 110 is directly attached to the head 30.

(2) According to the third embodiment, as the heat dissipating structure, both the heat dissipation fin 34 and the bracket 36 are provided. However, the structure may be such that only either is provided, such as only the heat dissipation fin 34 being provided in the head 30 as shown in FIG. 13.

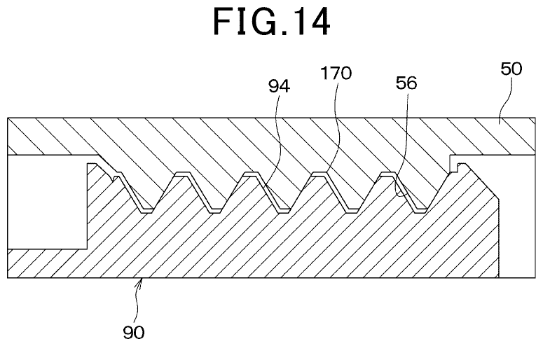

(3) According to the above-described embodiments, the low thermal-conductivity member 140 is disposed between the male screw thread 56 of the lens barrel 50 and the female screw thread 94 of the lens fixing portion 90. However, the structure may be such that the low thermal-conductivity member 140 is not provided. In addition, in a case in which the lens barrel 50 and the lens fixing portion 90 are fixed by a screw structure, a gap is preferably provided between the male screw thread 56 and the female screw thread 94. As shown in FIG. 14, a thread of the male screw thread 56 and a thread of the female screw thread 94 are each formed into a shape in which triangular shapes are repeated, when viewed on a cross-section. In this case, of two pairs of adjacent sides of the triangles configuring the threads, one pair of sides is in contact and the other pair is separated. A gap 170 is formed therebetween the pair of sides that is separated. In this manner, as a result of the gap 170 being formed between the male screw thread 56 and the female screw thread 94, heat resistance can be further increased, and heat can be less easily transferred from the lens fixing portion 90 to the lens barrel 50.

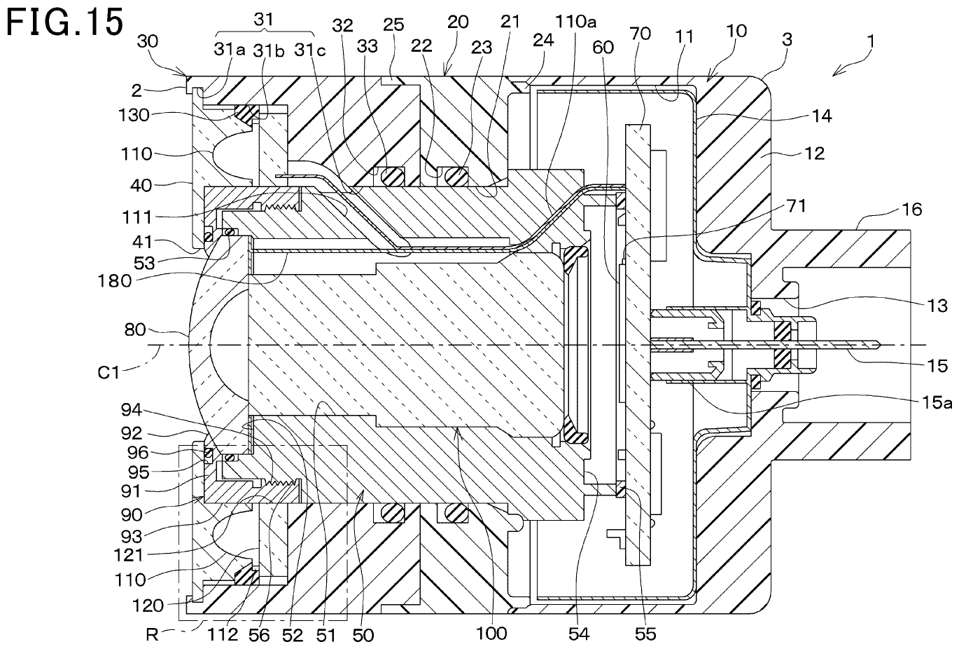

(4) According to the above-described embodiments, the lens 80 is defogged and de-iced due to the heat generated by the infrared irradiating unit 110. In addition, as shown in FIG. 15, the configuration may be such that a lens heater 180 is provided on a rear surface of the lens 80, and the lens 80 is defogged and de-iced by being heated by the lens heater 180. That is, in the configuration in which the lens 80 is defogged and de-iced based on the heat generated by the infrared irradiating unit 110, the lens heater 180 may or may not be provided. Of course, should the lens heater 180 be used in combination, heat generation by the infrared irradiating unit 110 and heat generation by the lens heater 180 can be selectively used. Therefore, the lens 80 can be more efficiently defogged and de-iced.

(5) According to the above-described embodiments, the infrared irradiating unit 110 may be directly mounted to the lens fixing portion 90 without the LED board 120 therebetween. In this case, the LED board 120 may be disposed in a portion of the lens fixing portion 90 in which the infrared irradiating unit 110 is not disposed.

(6) According to the above-described embodiments, the camera apparatus 1 in which the infrared irradiating unit 110 is the electromagnetic wave generator is given as an example of the sensor apparatus. In addition, the lens 80 serves as an electromagnetic wave transmission component configuring an electromagnetic wave reception opening, the lens fixing portion 90 serves as a fixing portion of the electromagnetic wave transmission component, the lens barrel 50 serves as a housing, the imager 60 serves an electromagnetic wave reception element, the imager board 70 serves as a control board on which the electromagnetic wave reception element and various elements driving the electromagnetic wave reception element are provided, and the LED board 120 serves as a mounting board on which the the infrared irradiating unit 110 is mounted. These are merely examples and the present disclosure can be applied to sensor apparatuses using other electromagnetic waves.

For example, the present disclosure can be applied to a sensor apparatus such as a millimeter-wave radar in which a millimeter wave is outputted as the electromagnetic wave, and a relative distance to an object is measured by the millimeter wave being received by a millimeter-wave receiving element. In the case of the millimeter-wave radar, the electromagnetic wave transmission component is a cover glass that covers a surface of the radar or the like. A component that configures a path through which the millimeter wave passes is the housing.

(7) According to the above-described embodiments, as the camera apparatus 1 corresponding to the sensor apparatus, the camera apparatus 1 that is mounted to a vehicle is given as an example. However, the sensor apparatus is not limited to that which is mounted to a vehicle. However, because distances between components are short in response to demands for compactness in vehicle-mounted sensor apparatuses, there is an issue in that heat is easily transferred from the electromagnetic wave generator to the board on which the electromagnetic wave reception element and various elements driving the electromagnetic wave reception element are mounted. Therefore, the present disclosure is particularly useful when applied to a vehicle-mounted sensor apparatus that has been made compact.

In addition, according to the present embodiment, an example is described in which the rear end 3 side of the lens barrel 50 is coupled with the imager board 70 by the adhesive material 55. However, a method for coupling the imager board 70 and the lens barrel 50 is not limited. For example, the imager board 70 and the lens barrel 50 may be coupled by soldering. Alternatively, the configuration may be such that the imager board 70 is coupled with the cover 10 or the case 20 by a screw or the like, and heat is transferred to the lens barrel 50 through the cover 10 or the case 20. This configuration is particularly useful for a sensor apparatus in which the lens barrel 50 serves as a path for heat. A quantity of substrates inside the sensor element is not limited to two, that is, the imager board 70 and the LED board 120 as in the present disclosure. Three or more substrates may be provided such as by the imager board 70 being configured by a plurality of substrates.

(8) The above-described embodiments are not unrelated to each other and can be combined as appropriate unless combining is clearly not possible. In addition, according to the above-described embodiments, it goes without saying that an element that configures an embodiment is not necessarily a requisite unless particularly specified as being a requisite, clearly considered a requisite in principle, or the like. Furthermore, according to the above-described embodiments, in cases in which a numeric value, such as quantity, numeric value, amount, or range, of a constituent element according to an embodiment is stated, the present disclosure is not limited to the specific number unless particularly specified as being a requisite, clearly limited to the specific number in principle, or the like. Moreover, according to the above-described embodiments, when a shape, a positional relationship, or the like of a constituent element or the like is mentioned, excluding cases in which the shape, the direction, the positional relationship, or the like is clearly described as particularly being a requisite, is clearly limited to a specific shape, positional relationship, or the like in principle, or the like, the present disclosure is not limited to the shape, positional relationship, or the like.

### Aspects of the Present Disclosure

The present disclosure described above can, for example, be understood according to the following aspects.

### First Aspect

A sensor apparatus, including: a housing container (10 to 30); an electromagnetic wave generator (110) that is housed in the housing container, outputs an electromagnetic wave outside the housing container, and generates heat in accompaniment with generating the electromagnetic wave; an electromagnetic wave transmission component (80) that is housed in the housing container, configures an electromagnetic wave reception opening that receives the electromagnetic wave reflected by an object outside the housing container, and transmits the electromagnetic wave; a sensing element (60) that is disposed further toward an inner side of the housing container than the electromagnetic wave transmission component is; a control board (70) that is disposed further toward an inner side of the housing container than the electromagnetic wave transmission component, controls the sensing element is, and switches between the electromagnetic wave generator outputting the electromagnetic wave and the electromagnetic wave generator not outputting the electromagnetic wave; a housing (50) that is disposed between the electromagnetic wave transmission component and the sensing element and the control board, and configures a path guiding the electromagnetic wave transmitted through the electromagnetic wave transmission component to the sensing element; and a fixing portion (90) that is configured as a separate member from the housing and fixes the electromagnetic wave transmission component to the housing, in which the electromagnetic wave generator generates heat during output of the electromagnetic wave and the heat is transferred to the electromagnetic wave transmission component through the fixing portion.

### Second Aspect

The sensor apparatus according to a second aspect, in which the control board detects at least either of a first temperature that is a temperature of the sensing element and a second temperature that is a temperature of the electromagnetic wave generator, and automatically switches between the electromagnetic wave generator outputting the electromagnetic wave and the electromagnetic wave generator not outputting the electromagnetic wave based on a sensing result for the electromagnetic wave from the sensing element, the first temperature, and the second temperature.

### Third Aspect

The sensor apparatus according to a second aspect, in which the control board reduces a proportion of generation of the electromagnetic wave per unit time by performing either of an intermittent operation and a selective operation when a detection result indicates that the first temperature or the second temperature is a high temperature, compared to when the first temperature and the second temperature are not a high temperature, the intermittent operation being the electromagnetic wave generator intermittently outputting the electromagnetic wave and the selective operation being, when a plurality of electromagnetic wave generators are provided, only a portion of the plurality of electromagnetic wave generators outputting the electromagnetic waves.

### Fourth Aspect

The sensor apparatus according to any one of the first to third aspects, in which the electromagnetic wave generator is directly mounted to the fixing portion.

### Fifth Aspect

The sensor apparatus according to any one of the first to third aspects, further including: a mounting board (120) on which the electromagnetic wave generator is mounted, in which the electromagnetic wave generator is connected to the fixing portion by the mounting board.

### Sixth Aspect

The sensor apparatus according to the fifth aspect, in which the mounting board is connected to the fixing portion by a high thermal-conductivity member (150) that more easily transfers heat than when the mounting board and the fixing portion are in direct contact.

### Seventh Aspect

The sensor apparatus according to any one of the first to sixth aspects, in which a low thermal-conductivity member (140) that less easily transfers heat than when the housing and the fixing portion are in direct contact is disposed between the housing and the fixing portion.

### Eighth Aspect

The sensor apparatus according to any one of the first to sixth aspects, in which a male screw thread (56) is formed in the housing and a female screw thread (94) is formed in the fixing portion; the fixing portion is fixed to a tip end of the housing on the electromagnetic wave transmission component side by the male screw thread and the female screw thread being engaged; and a gap (170) is formed between a thread of the male screw thread and a thread of the female screw thread.

### Ninth Aspect

The sensor apparatus according to any one of the first to eight aspects, in which the housing container includes a head (30) that houses the electromagnetic wave generator, the electromagnetic wave transmission component, and the fixing portion; the head has a structure that is integrated with a bracket (36) that is attached to an attached member (4) to which the sensor apparatus is attached; and heat generated by the electromagnetic wave generator is transferred to the head and further transferred to the attached member through the bracket.

### Tenth Aspect

The sensor apparatus according to any one of the first to ninth aspects, in which the sensor apparatus is a vehicle-mounted camera apparatus attached to a vehicle (4).

### Eleventh Aspect

The sensor apparatus according to the tenth aspect, in which the electromagnetic wave generator is an infrared irradiating unit (110) that is configured by a semiconductor light source composed of any of an infrared light emission diode, a vertical-cavity surface-emitting laser, and a photonic crystal surface-emitting laser that output an infrared light as the electromagnetic wave; the sensing element is an imager (60) that captures images of outside the sensor apparatus; the control board is an imager board (70) that performs control of the imager; the electromagnetic wave transmission component is a lens (80) that receives reflected light of the infrared light outputted from the infrared irradiating unit; and the housing is a lens barrel (50) that guides the reflected light of the infrared light received by the lens to the imager.

### Twelfth Aspect

The sensor apparatus according to the eleventh aspect, in which an optical axis (L) of the infrared irradiating unit is inclined relative to an optical axis (C1) of the lens barrel.

### Thirteenth Aspect

The sensor apparatus according to the eleventh or twelfth aspect, in which the electromagnetic wave transmission component is composed of a material having lower thermal conductivity than that of the housing.

### Fourteenth Aspect

The sensor apparatus according to any one of the eleventh to thirteenth aspects, in which the optical axis of the lens barrel is inclined at an angle equal to or greater than 15° to a straight line (C2) in a longitudinal direction of the vehicle, and disposed such that a traveling airflow (7) of the vehicle flows to the electromagnetic wave transmission component side after coming into contact with the fixing portion.

### Fifteenth Aspect

The sensor apparatus according to the first aspect, in which the sensor apparatus is a vehicle-mounted camera apparatus that is mounted in a vehicle (4); the electromagnetic wave generator is an infrared irradiating unit (110) that is configured by a semiconductor light source composed of any of an infrared light emission diode, a vertical-cavity surface-emitting laser, and a photonic crystal surface-emitting laser that output an infrared light as the electromagnetic wave; the sensing element is an imager (60) that captures images of outside the camera apparatus; the control board is an imager board (70) that performs control of the imager; the electromagnetic wave transmission component is a lens (80) that receives reflected light of the infrared light outputted from the infrared irradiating unit; and the housing is a lens barrel (50) that guides the reflected light of the infrared light received by the lens to the imager; and the imager board acquires vehicle speed information, and reduces a proportion of generation of the electromagnetic wave per unit time by performing either of an intermittent operation and a selective operation when a vehicle speed indicated by the vehicle speed information is equal to or less than a predetermined vehicle speed threshold, compared to when the vehicle speed is greater than the vehicle speed threshold, the intermittent operation being the electromagnetic wave generator intermittently outputting the electromagnetic wave and the selective operation being, when a plurality of electromagnetic wave generators are provided, only a portion of the plurality of electromagnetic wave generators outputting the electromagnetic waves.

What is claimed is:

1. A sensor apparatus comprising:
a housing container;
an electromagnetic wave generator that is housed in the housing container, outputs an electromagnetic wave outside the housing container, and generates heat in accompaniment with generating the electromagnetic wave;
an electromagnetic wave transmission component that is housed in the housing container, configures an electromagnetic wave reception opening that receives the electromagnetic wave reflected by an object outside the housing container, and transmits the electromagnetic wave;
a sensing element that is disposed further toward an inner side of the housing container than the electromagnetic wave transmission component is;
a control board that is disposed further toward an inner side of the housing container than the electromagnetic wave transmission component is, controls the sensing element, and switches between the electromagnetic wave generator outputting the electromagnetic wave and the electromagnetic wave generator not outputting the electromagnetic wave;
a housing that is disposed between the electromagnetic wave transmission component and the sensing element and the control board, and configures a path guiding the electromagnetic wave transmitted through the electromagnetic wave transmission component to the sensing element; and
a fixing portion that is configured as a separate member from the housing and fixes the electromagnetic wave transmission component to the housing, wherein
the electromagnetic wave generator generates heat during output of the electromagnetic wave and the heat is transferred to the electromagnetic wave transmission component through the fixing portion.

2. The sensor apparatus according to claim 1, wherein:
the control board detects at least either of a first temperature that is a temperature of the sensing element and a second temperature that is a temperature of the electromagnetic wave generator, and automatically switches between the electromagnetic wave generator outputting the electromagnetic wave and the electromagnetic wave generator not outputting the electromagnetic wave based on a sensing result for the electromagnetic wave from the sensing element, the first temperature, and the second temperature.

3. The sensor apparatus according to claim 2, wherein:
the control board reduces a proportion of generation of the electromagnetic wave per unit time by performing either of an intermittent operation and a selective operation when a detection result indicates that the first temperature or the second temperature is a high temperature, compared to when the first temperature and the second temperature are not a high temperature, the intermittent operation being the electromagnetic wave generator intermittently outputting the electromagnetic wave and the selective operation being, when a plurality of electromagnetic wave generators are provided, only a portion of the plurality of electromagnetic wave generators outputting the electromagnetic waves.

4. The sensor apparatus according to claim 1, wherein:
the electromagnetic wave generator is directly mounted to the fixing portion.

5. The sensor apparatus according to claim 1, further comprising:
a mounting board on which the electromagnetic wave generator is mounted, wherein
the electromagnetic wave generator is connected to the fixing portion by the mounting board.

6. The sensor apparatus according to claim 5, wherein:
the mounting board is connected to the fixing portion by a high thermal-conductivity member that more easily transfers heat than when the mounting board and the fixing portion are in direct contact.

7. The sensor apparatus according to claim 1, wherein:
a low thermal-conductivity member that less easily transfers heat than when the housing and the fixing portion are in direct contact is disposed between the housing and the fixing portion.

8. The sensor apparatus according to claim 1, wherein:
a male screw thread is formed in the housing and a female screw thread is formed in the fixing portion;
the fixing portion is fixed to a tip end of the housing on the electromagnetic wave transmission component side by the male screw thread and the female screw thread being engaged; and
a gap is formed between a thread of the male screw thread and a thread of the female screw thread.

9. The sensor apparatus according to claim 1, wherein:
the housing container includes a head that houses the electromagnetic wave generator, the electromagnetic wave transmission component, and the fixing portion;
the head has a structure that is integrated with a bracket that is attached to an attached member to which the sensor apparatus is attached; and
heat generated by the electromagnetic wave generator is transferred to the head and further transferred to the attached member through the bracket.

10. The sensor apparatus according to claim 1, wherein:
the sensor apparatus is a vehicle-mounted camera apparatus attached to a vehicle.

11. The sensor apparatus according to claim 10, wherein:
the electromagnetic wave generator is an infrared irradiating unit that is configured by a semiconductor light source composed of any of an infrared light emission diode, a vertical-cavity surface-emitting laser, and a photonic crystal surface-emitting laser that output an infrared light as the electromagnetic wave;
the sensing element is an imager that captures images of outside the sensor apparatus;
the control board is an imager board that performs control of the imager;
the electromagnetic wave transmission component is a lens that receives reflected light of the infrared light outputted from the infrared irradiating unit; and
the housing is a lens barrel that guides the reflected light of the infrared light received by the lens to the imager.

12. The sensor apparatus according to claim 11, wherein:
an optical axis of the infrared irradiating unit is inclined relative to an optical axis of the lens barrel.

13. The sensor apparatus according to claim 11, wherein:
the electromagnetic wave transmission component is composed of a material having lower thermal conductivity than that of the housing.

14. The sensor apparatus according to claim 11, wherein:
the optical axis of the lens barrel is inclined at an angle equal to or greater than 15° to a straight line in a longitudinal direction of the vehicle, and disposed such that a traveling airflow of the vehicle flows to the electromagnetic wave transmission component side after coming into contact with the fixing portion.

15. The sensor apparatus according to claim 1, wherein:
the sensor apparatus is a vehicle-mounted camera apparatus that is mounted in a vehicle;
the electromagnetic wave generator is an infrared irradiating unit that is configured by a semiconductor light source composed of any of an infrared light emission diode, a vertical-cavity surface-emitting laser, and a photonic crystal surface-emitting laser that output an infrared light as the electromagnetic wave;
the sensing element is an imager that captures images of outside the camera apparatus;
the control board is an imager board that performs control of the imager;
the electromagnetic wave transmission component is a lens that receives reflected light of the infrared light outputted from the infrared irradiating unit; and
the housing is a lens barrel that guides the reflected light of the infrared light received by the lens to the imager; and
the imager board acquires vehicle speed information, and reduces a proportion of generation of the electromagnetic wave per unit time by performing either of an intermittent operation and a selective operation when a vehicle speed indicated by the vehicle speed information is equal to or less than a predetermined vehicle speed threshold, compared to when the vehicle speed is greater than the vehicle speed threshold, the intermittent operation being the electromagnetic wave generator intermittently outputting the electromagnetic wave and the selective operation being, when a plurality of electromagnetic wave generators are provided, only a portion of the plurality of electromagnetic wave generators outputting the electromagnetic waves.

16. The sensor apparatus according to claim 2, wherein:
the electromagnetic wave generator is directly mounted to the fixing portion.

17. The sensor apparatus according to claim 3, wherein:
the electromagnetic wave generator is directly mounted to the fixing portion.

18. The sensor apparatus according to claim 2, further comprising:
a mounting board on which the electromagnetic wave generator is mounted, wherein
the electromagnetic wave generator is connected to the fixing portion by the mounting board.

19. The sensor apparatus according to claim 3, further comprising:
a mounting board on which the electromagnetic wave generator is mounted, wherein
the electromagnetic wave generator is connected to the fixing portion by the mounting board.

20. The sensor apparatus according to claim 12, wherein:
the optical axis of the lens barrel is inclined at an angle equal to or greater than 15° to a straight line in a longitudinal direction of the vehicle, and disposed such that a traveling airflow of the vehicle flows to the electromagnetic wave transmission component side after coming into contact with the fixing portion.
